(19) United States
(12) Patent Application Publication
(10) Pub. No.: US 2007/0002805 A1
(43) Pub. Date: Jan. 4, 2007

(54) Control of antenna pattern

(75) Inventors: Juha K. Laurila, Espoo (FI); Hannu Kauppinen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/212,699

(22) Filed: Aug. 29, 2005

(30) Foreign Application Priority Data
Jun. 29, 2005 (FI) 20055358

(51) Int. Cl. H04B 7/212

(52) U.S. Cl. 370/337

(57) ABSTRACT

An antenna pattern can be modified in a radio system including at least one user terminal and at least one base station. A user terminal and a base station communicate using at least two channels of different type with time slots of a time division multiple access method. The base station forms at least two different antenna patterns per each channel, the at least two antenna patterns of each channel differing from each other in a vertical direction during at least two different time slots.

### FIELD

The invention relates to modification of an antenna pattern of a transmitter in a radio system.

### BACKGROUND

A radio access network (RAN), usually including several base stations and at least one base station controller, causes the main cost of a radio system during its construction. In operation, each site also brings a maintenance burden in both technical and economical sense since the larger the number of sites, the higher the probability of defects and malfunctions requiring reparation. It is important to increase reliability and reduce costs particularly in emerging markets where implementation and technology are often related to the GSM (Global System for Mobile communication) system.

In general, an increase in a service area of a base station and in capacity is desirable, since the wider the coverage of a single base station, the smaller the number of base stations needed to cover a certain geographical area. When the sites are scattered at a long distance from each other or a large number of users is packed in a small coverage area, a radio system should be flexible to incorporate both low and high traffic loads. However, a straightforward increase of the service area of base stations can result in interference with neighbouring base stations.

A service area of a base station can be extended and interference can be controlled to a certain extent by modifying the antenna gain, which can be carried out by narrowing an antenna pattern in an azimuth direction. This, however, leads to increased sectorisation (e.g. six fixed 60° sectors, instead of three 120° sectors). The solution also doubles the number of power amplifiers required per site, causing complexity, difficulty to fit electronic components in a cabinet, heat dissipation and unwanted costs. Due to the narrowed sectors, the number of handovers increases which, in turn, increases signalling overhead and the probability of dropped calls.

### BRIEF DESCRIPTION OF THE INVENTION

An object of the invention is to provide an improved method of controlling an antenna pattern, an improved radio system and an improved base station. According to an aspect of the invention, there is provided a method of forming an antenna pattern in a radio system including at least one user terminal and at least one base station. The method comprises: communicating between a user terminal and a base station using at least two channels of different type with time slots of a time division multiple access method; and forming, by a base station, at least two different antenna patterns per each channel, the at least two antenna patterns of each channel differing from each other in a vertical direction during at least two different time slots of a predetermined period of time.

According to another aspect of the invention, there is provided a method of forming an antenna pattern in a radio system including at least one user terminal and at least one base station. The method comprises: communicating between a user terminal and a base station using time slots of a time division multiple access method; forming a timing advance for a time slot of each user, forming, by a base station, at least two different antenna patterns per one channel, the at least two antenna patterns differing from each other in a vertical direction, whereby forming an antenna pattern for each time slot of a traffic channel on the basis of the timing advance of the time slot, and forming different antenna patterns in at least two different time slots of a broadcast channel during a predetermined period of time.

According to another aspect of the invention, there is provided a radio system including at least one user terminal and at least one base station, wherein a user terminal and a base station is configured to communicate with each other using at least two channels of different type with time slots of a time division multiple access method, and the base station is configured to form at least two different antenna patterns per each channel, the at least two antenna patterns of each channel differing from each other in a vertical direction during at least two different time slots of a predetermined period of time.

According to another aspect of the invention, there is provided a radio system including at least one user terminal and at least one base station, wherein a user terminal and a base station is configured to communicate with each other using at least two channels of different type with time slots of a time division multiple access method; the radio system is configured to form a timing advance for a time slot of each user; the base station is configured to form at least two different antenna patterns per one channel, the at least two antenna patterns differing from each other in a vertical direction such that the base station is configured to form an antenna pattern for each time slot of a traffic channel on the basis of the timing advance of the time slot, and the base station is configured to form different antenna patterns in at least two different time slots of a broadcast channel during a predetermined period of time.

According to another aspect of the invention, there is provided a base station in a radio system including at least one user terminal and at least one base station, wherein a user terminal and a base station is configured to communicate with each other using at least two channels of different type with time slots of a time division multiple access method, and the base station is configured to form at least two different antenna patterns per each channel, the at least two antenna patterns of each channel differing from each other in a vertical direction during at least two different time slots of a predetermined period of time.

According to another aspect of the invention, there is provided a base station in a radio system including at least one user terminal and at least one base station, wherein a user terminal and a base station is configured to communicate with each other using at least two channels of different type with time slots of a time division multiple access method; and a timing advance for a time slot of each user is available; the base station is configured to form at least two different antenna patterns per one channel, the at least two antenna patterns differing from each other in a vertical direction such that the base station is configured to form an antenna pattern for each time slot of a traffic channel on the basis of the timing advance of the time slot, and the base station is configured to form different antenna patterns in at least two different time slots of a broadcast channel during a predetermined period of time.

The invention provides several advantages. The maximum range of a base station can be increased and interference caused by neighbouring cells can be reduced in an economical way.

### LIST OF DRAWINGS

In the following, the invention will be described in greater detail with reference to the embodiments and the accompanying drawings, in which

FIG. 1 shows a radio system,

FIG. 2 illustrates an antenna pattern of a dedicated channel,

FIG. 3 illustrates directions of antenna patterns of a dedicated channel in different time slots,

FIG. 4 illustrates antenna patterns of a broadcast channel,

FIG. 5 illustrates antenna structures,

FIG. 6 illustrates a flow chart of the method, and

FIG. 7 illustrates a more detailed flow chart of the method.

### DESCRIPTION OF EMBODIMENTS

The present solution is well-suited for use in a TDMA (Time Division Multiple Access) based radio system such as a GSM radio system or a GSM/EDGE (GSM/Enhanced Data rates for Global Evolution) radio system, the invention not, however, being restricted to them. The present solution can be applied to any radio system where transmission takes place at least partly as bursts in time slots of frames.

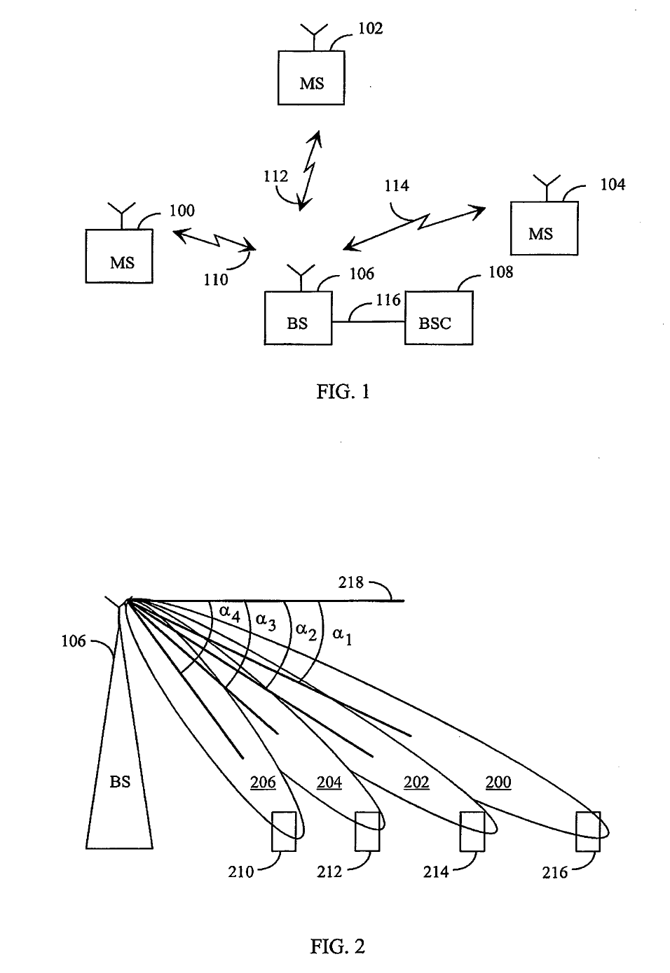

First, the radio system is described by means of FIG. 1. A typical digital radio system comprises subscriber equipment 100 to 104, also called subscriber terminals, at least one base station 106, and a base station controller 108, which can also be called a radio network controller. The base station 106 can be connected to the base station controller 108 by a digital trans-mission link 116. The subscriber terminal 100 to 104 communicates with the base station 106 over an air interface. Signals 110 to 114 can be communicated in logical channels of different type, such as a traffic channel (TCH) or a broadcast channel (BCCH). The broadcast channel can be considered an example of a general channel usually transmitted with an equal power to the whole cell area. The general channel carries control information to all users within the coverage of a base station. The logical channels are mapped onto physical channels for transmission over the air interface which are made up of time slots of a time division multiple access method. The subscriber terminals 100 to 104 may be fixedly installed terminals, user terminals installed in a vehicle or portable mobile terminals. The signals 110 to 114 between the subscriber terminal 100 to 104 and the base station 106 carry digitised information, which is e.g. speech or data information produced by subscribers or control information produced by the radio system. In a time division multiple access radio system or in a general packet radio system, signals are transmitted using slots.

In general in the present solution, the base station 106 can form at least two different antenna patterns per each logical channel in one carrier frequency. The at least two antenna patterns of each logical channel can differ from each other in a vertical direction. The difference may be a tilt angle of the pattern which may additionally be enhanced by shaping the pattern. The antenna patterns do not appear at the same time but are used at the moments of at least two different time slots. The antenna patterns can be used for transmission at the moments of at least two different time slots during a predetermined period of time.

FIG. 2 illustrates antenna patterns of a traffic channel according to an embodiment. In this solution, the antenna patterns 200 to 206 of the base station 106 are directed towards user terminals 210 to 216 and since the user terminals 210 to 216 are at a different distance from the base station 106, the base station 106 forms different antenna patterns for them.

Since the antenna pattern in this solution is directed towards a user, a parameter relating to the distance between a user terminal and a base station can be used for controlling the direction of the antenna pattern. The base station 106 can form a timing advance by determining the position of a training sequence in a time slot transmitted by a subscriber terminal 210 to 216. The timing advance can also be formed by some other network element and delivered to the base station 106. The timing advance is in relation to the time for the radiation to travel the distance between the user terminal 210 to 216 and the base station 106. Since the traffic channel is a dedicated channel, each traffic channel belongs to a single user. Hence, the base station can modify the antenna patterns separately for each user such that the antenna pattern used at the moment of each time slot is formed on the basis of the timing advance of the time slot.

For example, in the GSM radio system a frame includes eight time slots in one carrier frequency, each time slot usually belonging to a unique user. However, every now and then a time slot is used for broadcast. Hence, the base station 106 can transmit to the user terminals 210 to 216 in the same frame and in the same frequency. When a time slot changes also a user changes. If different users are at a different distance from the base station, the antenna pattern can be modified suitably according to their distance.

In FIG. 2, the base station 106 can form four antenna patterns 200 to 206 having different tilting angles, but in general there are at least two antenna patterns for each traffic channel. The tilt angles α₁, α₂, α₃ and α₄ of the antenna patterns 200 to 206 can be defined as angles between a horizontal line 218 and the lines in the middle of the antenna patterns 200 to 206.

The base station 106 can tilt the antenna pattern of the traffic channel such that the tilt angle is larger (for example pattern 206) with a smaller timing advance and the tilt angle is smaller (for example pattern 200) with a larger timing advance. In this way, the antenna pattern extends the further the longer the user terminal is away from the base station and, correspondingly, the antenna pattern is directed the closer the shorter the distance between the user terminal and the base station.

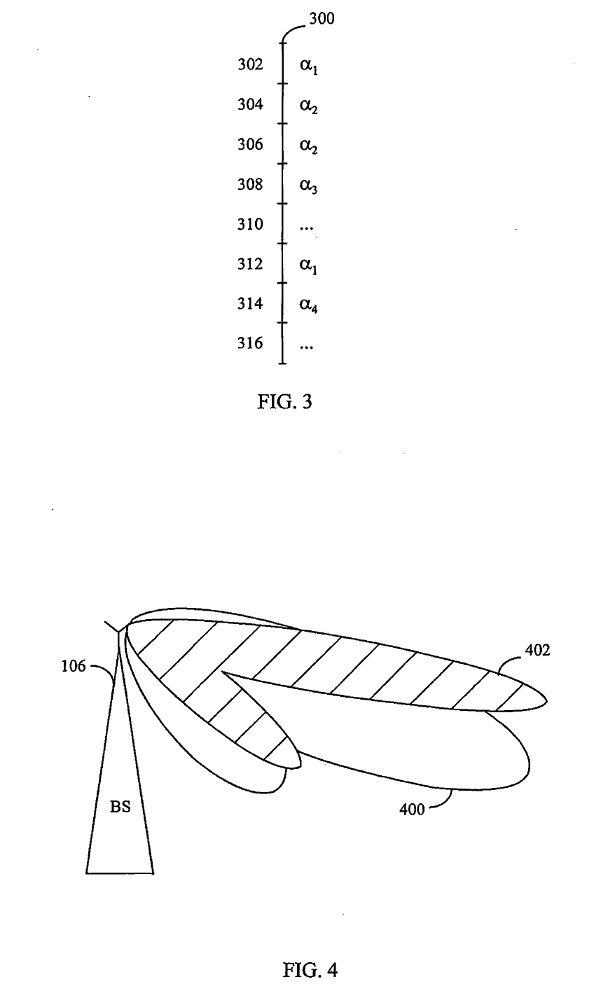

FIG. 3 shows four tilt angles α₁, α₂, α₃ and α₄ (which refer to different antenna patterns of the traffic channel) as a function of time slots 302 to 316 in a frame 300. The tilt angles can be considered to refer to the same angles as in FIG. 2. In the first time slot 302, the tilt angle is α₁ which means that the user terminal is very far from the base station. In the second time slot 304, the tilt angle is α₂ which means that the user terminal is far from the base station. In the third time slot 306, the tilt angle is α₂ which means that the user terminal is far from the base station. In the forth time slot 308, the tilt angle is α₃ which means that the user terminal is close to the base station. In the fifth time slot 310, there is no transmission. In the sixth time slot 312, the tilt angle is α₂ which means that the user terminal is far from the base station. In the seventh time slot 314, the tilt angle is α₄ which means that the user terminal is very close to the base station. In the fifth time slot 316, there is no traffic transmission.

FIG. 4 illustrates antenna patterns of a broadcast channel according to an embodiment. The antenna antenna pattern can be made adaptive so that in some time slot(s) of a TDMA frame the antenna pattern is narrower in an elevation direction than in other time slots, and therefore a higher antenna gain is observed. Thus, users located close to the cell edge observe momentarily a higher received broadcast power. When performing measurements for handover or random access purposes, the terminal can perform averaging on many frames. Therefore, a higher broadcast power can be received also on average. In practice, this leads to cell range extension.

The base station forms different antenna patterns 400, 402 for at least two different time slots of a broadcast channel during a predetermined period of time. The predetermined period of time may be a frame or some other specified period of time which may be longer or shorter than the frame. To form different antenna patterns 400, 402, the base station 106 may form a modified antenna pattern 402 in at least one time slot of a broadcast channel during a predetermined period of time, the antenna pattern 400 having an unmodified shape and direction in other time slots of the predetermined period of time. The base station 106 may form different antenna patterns per one channel by tilting the antenna patterns 400, 402 in a different manner in a vertical direction. In this way, the antenna pattern 400 may be a standard and unmodified antenna pattern while the antenna patter 402 may be a modified antenna pattern directed further to extend the range of reception and hence the service area of the base station. Since the antenna patterns are used at different moments (of at least two different time slots), the antenna patterns 400, 402 do not appear at the same time.

In addition to modifying the tilt angle, the shape of the antenna pattern of both a traffic channel and a broadcast channel can be modified.

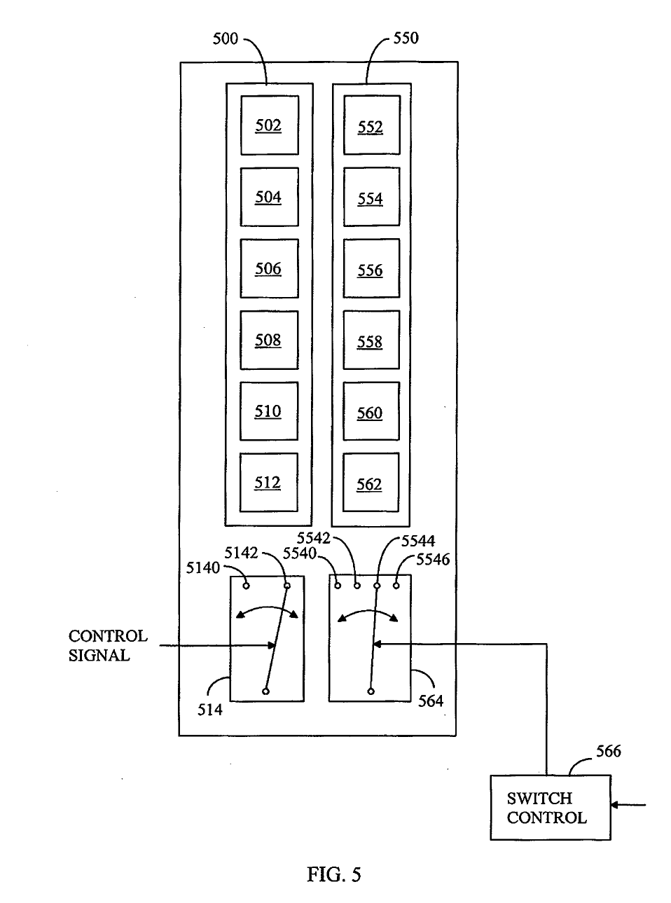

FIG. 5 shows an antenna implementation of the present solution. A combined antenna can include an antenna column 500 for a broadcast channel and an antenna column 550 for a traffic channel. The antenna column 500 for the broadcast channel has a plurality of antenna elements 502 to 512 in a vertical direction and in this example the base station can form two antenna patterns for broadcast. The antenna pattern of the antenna column 500 can be changed by changing the phase differences of the carrier fed to the antenna elements 502 to 512. A switch 514 can be used for selecting a suitable phasing from among a predetermined set of phase differences of the antenna elements 502 to 512. In this example, the number of alternatives in the predetermined set is two, and hence the switch 514 interchangeably feeds a broadcast signal to two terminals 5140, 5142, from which the broadcast signal proceeds to the antenna elements 502 to 512. When the broadcast signal is switched through the terminal 5140, the phase differences between the antenna elements 502 to 512 and thus the antenna pattern are different than when switched through the terminal 5142.

The switch 514 can change the terminal at a regular rate synchronously with the time slots. The operation of the switch 514 can be controlled by a clock of the base station to achieve synchronization. For example, every second time broadcast can be transmitted using a standard antenna pattern while at other moments the broadcast can be transmitted using a modified antenna pattern which can be received further than the broadcast transmitted using the standard antenna pattern.

The antenna column 550 for the traffic channel includes a plurality of antenna elements 552 to 562 in a vertical direction and in this example the base station can form four antenna patterns for the traffic channel. As in connection with the broadcast antenna column 500, the antenna pattern of the antenna column 550 can be changed by changing the phase differences of the carrier fed to the antenna elements 552 to 562. A switch 564 can be used for selecting a suitable phasing from among a predetermined set of phase differences of the antenna elements 502 to 512. In this example, the number of alternatives in the predetermined set is four, and hence the switch 514 interchangeably feeds the broadcast signal to four terminals 5540, 5546, from which a broadcast signal proceeds to the antenna elements 552 to 562. When the broadcast signal is switched through one terminal 5540 to 5546, the phase differences between the antenna elements 552 to 562 and thus the antenna pattern are different than when switched through any other terminal.

The switch 564 can change the terminal at a regular rate synchronously with the time slots. The operation of the switch 564 can be controlled by a switch control 566 the input of which is a timing advance. The switch control 566 turns the switch 564 according to the timing advance such that an antenna pattern for a certain user is active during a time slot related to the user.

The switches 514, 564 may be RF switches which can route radio frequency signals. A switching delay of an RF switch is short (in the range of some nanoseconds). The phase of the signals proceeding to the elements of the antenna can be controlled by multiplying each with a complex coefficient. The phase of the signals proceeding to the elements of the antenna can also be controlled by different delays.

Instead of a traffic channel any other dedicated channel can be transmitted in a manner similar to transmitting a traffic channel. Correspondingly, instead of a broadcast channel, any other general channel which is meant for all subscriber terminals in a cell can be transmitted in a manner similar to transmitting a broadcast channel.

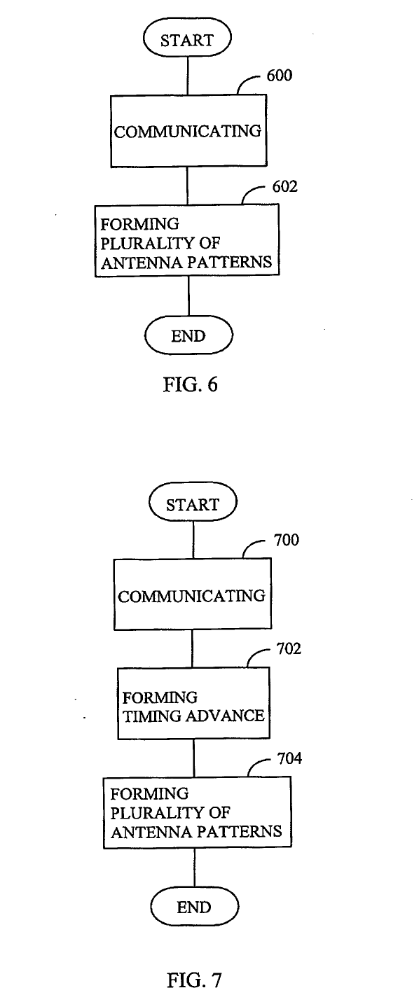

FIG. 6 shows a flow chart of the method of forming an antenna pattern in a radio system which includes at least one user terminal and at least one base station. In step 600, a user terminal and a base station are communicating using at least two channels of different type with time slots of a time division multiple access method. In step 602, at least two different antenna patterns per each channel are formed by the base station, the at least two antenna patterns of each channel differing from each other in a vertical direction in at least two different time slots during a predetermined period of time.

FIG. 7 shows a more detailed flow chart of the method. In step 700, a user terminal and a base station are communicating using time slots of a time division multiple access method. In step 702, a timing advance for a time slot of each user is formed. In step 704, at least two different antenna patterns per one channel are formed, the at least two antenna patterns differing from each other in a vertical direction. An antenna pattern for each time slot of a traffic channel is formed on the basis of the timing advance of the time slot, and different antenna patterns in at least two different time slots of a broadcast channel are formed during a predetermined period of time.

The present solution extends the maximum range of a cellular base station and hence maximizes the coverage achieved by a single macrocellular base station and therefore minimizes the number of sites required to cover a certain geographical area. A range of a base station can be defined by means of the maximum tolerable path loss in link-budget calculations. Antenna gain, at both ends of the link, appears as a term in a link budget. Therefore, increasing the antenna gain by modifying the antenna pattern also extends a cell range correspondingly. A further goal is to minimize total costs of infrastructure and operation. The range extension is interesting, for example, from the point of view of emerging markets.

Additionally, the present solution enables interference pollution caused to the neighbouring cells (traffic channel transmission) to be reduced. This can change observed carrier-to-interference C/I distribution in the neighbouring cells. As a consequence, a higher system throughput or a possibility to reduce a frequency reuse distance may be observed.

Even though the invention has been described above with reference to an example according to the accompanying drawings, it is clear that the invention is not restricted thereto but it can be modified in several ways within the scope of the appended claims.

1. A method of forming an antenna pattern in a radio system including at least one user terminal and at least one base station, the method comprising:
communicating between the at least one user terminal and the at least one base station using at least two channels of different types with time slots of a time division multiple access method; and
forming, with the at least one base station, at least two different antenna patterns per channel, the at least two different antenna patterns per channel differing from each other in a vertical direction during at least two time slots of a predetermined period of time.

2. The method of claim 1, the method further comprising:
forming a timing advance for a time slot of each user, and forming an antenna pattern for each time slot of a traffic channel based on a timing advance of the time slot.

3. The method of claim 1, the method further comprising:
modifying the antenna pattern in at least one time slot of a channel transmitted to all users within a coverage of the at least one base station during a predetermined period of time, the antenna pattern being unmodified in other time slots.

4. The method of claim 1, the method further comprising:
forming different antenna patterns per channel by tilting the antenna patterns differently in the vertical direction.

5. The method of claim 2, the method further comprising:
tilting the antenna pattern of the traffic channel in the vertical direction such that a tilting angle is larger with a smaller timing advance and the tilting angle is smaller with a larger timing advance.

6. A method of forming an antenna pattern in a radio system including at least one user terminal and at least one base station, the method comprising:
communicating between a user terminal and a base station using time slots of a time division multiple access method;
forming a timing advance for a time slot of each user;
forming, by the at least one base station, at least two different antenna patterns per channel, the at least two different antenna patterns differing from each other in a vertical direction;
forming the antenna pattern for each time slot of a traffic channel based on the timing advance of the time slot; and
forming different antenna patterns in at least two different time slots of a broadcast channel during a predetermined period of time.

7. A radio system, comprising:
a user terminal; and
a base station,
wherein the user terminal and the base station are configured to communicate together using at least two channels of different types with time slots of a time division multiple access method, and
wherein the base station is configured to form at least two different antenna patterns per channel, the at least two different antenna patterns per channel differing from each other in a vertical direction during at least two different time slots of a predetermined period of time.

8. The radio system of claim 7, wherein the radio system is configured to form a timing advance for a time slot of each user, and the base station is configured to form an antenna pattern for each time slot of a traffic channel based on a timing advance of the time slot.

9. The radio system of claim 7, wherein the base station is configured to modify an antenna pattern in at least one time slot of a channel transmitted to all users within a coverage of the base station during a predetermined period of time, and the base station is configured to keep the antenna pattern unmodified in other time slots.

10. The radio system of claim 7, wherein the base station is configured to form different antenna patterns per channel by tilting the antenna patterns differently in a vertical direction.

11. The radio system of claim 8, wherein the base station is configured to tilt the antenna pattern of the traffic channel in the vertical direction such that a tilting angle is larger with a smaller timing advance and the tilting angle is smaller with a larger timing advance.

12. A radio system, comprising:
a user terminal; and
a base station, wherein the base station and the user terminal are configured to communicate together using at least two channels of different types with time slots using time division multiple access,
the radio system is configured to form a timing advance for a time slot of each user,
the base station is configured to form at least two different antenna patterns per channel, the at least two antenna patterns differing from each other in a vertical direction,
the base station is configured to form an antenna pattern for each time slot of a traffic channel based on the timing advance of the time slot, and
the base station is configured to form different antenna patterns in at least two different time slots of a broadcast channel during a predetermined period of time.

13. A base station in a radio system, comprising:
a user terminal; and
a base station,
wherein the user terminal and the base station are configured to communicate with each other using at least two channels of different types with time slots of a time division multiple access method, and
wherein the base station is configured to form at least two different antenna patterns per channel, the at least two antenna patterns per channel differing from each other in a vertical direction during at least two different time slots of a predetermined period of time.

14. The base station of claim 13, wherein the base station is configured to receive a timing advance for a time slot of each user, and the base station is configured to form an antenna pattern for each time slot of a traffic channel based on a timing advance of the time slot.

15. The base station of claim 13, wherein the base station is configured to modify an antenna pattern in at least one time slot of a channel transmitted to all users within a coverage of the base station during a predetermined period of time, and the base station is configured to keep the antenna pattern unmodified in other time slots.

16. The base station of claim 13, wherein the base station is configured to form different antenna patterns per channel by tilting the antenna patterns differently in a vertical direction.

17. The base station of claim 14, wherein the base station is configured to tilt the antenna pattern of the traffic channel in the vertical direction such that a tilting angle is larger with a smaller timing advance and the tilting angle is smaller with a larger timing advance.

18. A base station in a radio system, comprising:
a user terminal; and
a base station,
wherein the user terminal and the base station are configured to communicate together using at least two channels of different types with time slots of a time division multiple access method, and
the base station is configured to form at least two different antenna patterns per channel, the at least two different antenna patterns differing from each other in a vertical direction,
the base station is configured to form an antenna pattern for each time slot of a traffic channel based on a timing advance of a time slot of each user, and
the base station is configured to form different antenna patterns in at least two different time slots of a broadcast channel during a predetermined period of time.
